(19) United States
(12) Patent Application Publication
(10) Pub. No.: US 2015/0097735 A1
(43) Pub. Date: Apr. 9, 2015

(54) ANTENNA ASSEMBLY AND ELECTRONIC DEVICE

(71) Applicant: SAMSUNG ELECTRO-MECHANICS CO., LTD., Suwon-Si (KR)

(72) Inventors: Jong Lae KIM, Suwon-Si (KR); Stakanov SERGEY, Suwon-Si (KR); Dae Seong JEON, Suwon-Si (KR)

(73) Assignee: SAMSUNG ELECTRO-MECHANICS CO., LTD., Suwon-Si (KR)

(21) Appl. No.: 14/249,067

(22) Filed: Apr. 9, 2014

(30) Foreign Application Priority Data
Oct. 4, 2013 (KR) 10-2013-0118811
Dec. 20, 2013 (KR) 10-2013-0160631

(51) Int. Cl. H01Q 1/24; H01Q 1/52

(52) U.S. Cl. CPC H01Q 1/243; H01Q 1/52
USPC 343/702; 343/867

(57) ABSTRACT

An antenna assembly antenna assembly may include: an antenna module disposed inside a cover disposed inside or outside of an electronic device; and an auxiliary antenna module electromagnetically coupled to the antenna module so as to provide a path via which eddy currents generated by the antenna module are guided.

### CROSS-REFERENCE TO RELATED APPLICATION

This application claims the benefit of Korean Patent Application No. 10-2013-0118811, filed on Oct. 4, 2013, and 10-2013-0160631, filed on Dec. 20, 2013, with the Korean Intellectual Property Office, the disclosures of which are incorporated herein by reference.

### BACKGROUND

The present disclosure relates to an antenna assembly and an electronic device.

In general, antennas may be divided into external antennas installed outside electronic devices and internal antennas installed inside electronic devices. Among the two, internal antennas are attracting attention since they have various advantages, such as convenience in use and superior design features.

As communications technology evolves, mobile terminals such as mobile phones have been implemented with multiple functions, including a telephone function, a text communications function, a mobile payment function and the like, and the types of internal antennas required therefor have accordingly been diversified.

In addition, as the design of mobile phones has advanced, the screens of mobile phone screens have become larger while the thicknesses thereof have been reduced. Accordingly, it is necessary to reinforce such mobile phones, such that covers (or cases, hereinafter collectively referred to as covers) that form outer casings thereof are increasingly formed of metal.

Unfortunately, covers formed of metal may have a negative influence on the performance of mobile phone antennas, and may make mobiles phones sensitive to human bodies.

Therefore, in the case of mobile phones with metal covers, when an antenna for primary communications, as well as antennas for GPS, BT/WiFi, and the like, are installed on upper and lower sides of the cover, resulting in the entirety of the cover being formed of metal, deteriorating antenna performance. In order to overcome this shortcoming, at least a portion of a cover in which an antenna is installed may be formed of a material other than metal, for example.

Further, near field communication (NFC) antennas, recently having been employed in mobile phones, may be installed in regions other than the above-described regions in which antennas for primary communications as well as antennas for GPS, BT/WiFi and the like are installed. For example, an NFC antenna may be installed in or near the center of the rear surface of a mobile phone, relative to locations of other antennas, such as in a location directly on a battery or on the cover above the battery. Thus, the performance of such an NFC antenna may be deteriorated when a cover formed of metal material is employed therewith.

As mentioned above, a cover formed of metal may deteriorate the performance of a mobile phone employing a NFC antenna, such that the upper and lower sides thereof in which the antennas for primary communications and the antennas for GPS, BT/WiFi and the like are installed are often formed of non-metal material, such as plastic.

However, manufacturing the cover of a mobile terminal with different materials, i.e., metal and a non-metal material, results in complicated processes requiring excessive amounts of time and costs.

Moreover, when an NFC antenna is employed in a mobile terminal with a metal cover, a pattern coil for the NFC antenna is installed inside the metal cover, and opposing magnetic fields occur, according to Lenz's law, so that an eddy current is created in the opposite direction to the direction in which the current flows in an antenna pattern coil, thereby disturb current flow in the antenna pattern coil. Therefore, the performance of the NFC antenna may be deteriorated.

In this regard, there has been an approach to improve the performance of the NFC antenna in such a manner that a physical slit is formed so that a hole in a cover of a mobile phone is extended to the edge of the metal portion of the cover so as to reduce eddy currents.

However, the slit formed in the metal cover may spoil the cosmetic appearance of such mobile phones. For this reason, additional processes are necessary, such as a process of adding an additional member to hide such a slit to and the painting thereof.

Furthermore, as described above, since covers of electronic devices such as smartphones are increasingly being formed of metal, it is desired to utilize the metal cover itself as an antenna.

### SUMMARY

An aspect of the present disclosure may provide an antenna assembly and an electronic device capable of changing the path of eddy currents without a physical slit being formed in a cover.

According to an aspect of the present disclosure, an antenna assembly may include: an antenna module disposed inside a cover disposed inside or outside of an electronic device; and an auxiliary antenna module electromagnetically coupled to the antenna module so as to provide a path via which eddy currents generated by the antenna module are guided.

According to another aspect of the present disclosure, an antenna assembly may include: a cover disposed inside or outside of an electronic device; an antenna module disposed inside the cover; and an auxiliary antenna module disposed inside the cover, the auxiliary antenna module electromagnetically coupled to the antenna module so as to provide a path via which eddy currents generated by the antenna module are guided, wherein the antenna module is disposed in a body of the electronic device.

According to another aspect of the present disclosure, an antenna assembly may include: a cover disposed inside or outside of an electronic device; an antenna module disposed inside the cover; an auxiliary antenna module disposed inside the cover, the auxiliary antenna module electromagnetically coupled to the antenna module so as to provide a path via which eddy currents generated by the antenna module are guided; and an insulating film disposed between the auxiliary antenna module and the antenna module, wherein the antenna module is disposed in the auxiliary antenna module while being insulated from the auxiliary antenna module by the insulating film.

According to another aspect of the present disclosure, an electronic device may include: a cover disposed inside or outside of an electronic device; an antenna module disposed inside the cover; and an auxiliary antenna module disposed inside the cover, the auxiliary antenna module electromagnetically coupled to the antenna module so as to provide a path via which eddy currents generated by the antenna module are guided; and a body of the electronic device in which the antenna module is disposed.

The antenna assembly described above may further include: an insulating film disposed between the auxiliary antenna module and the antenna module.

According to another aspect of the present disclosure, an electronic device may include: a cover disposed inside or outside the electronic device; an antenna module disposed inside the cover; an auxiliary antenna module disposed inside the cover, the auxiliary antenna module electromagnetically coupled to the antenna module so as to provide a path via which eddy currents generated by the antenna module are guided; an insulating film disposed between the auxiliary antenna module and the antenna module; and a body of the electronic device having an electrical circuit electrically connected to the antenna module, wherein the antenna module is disposed in the auxiliary antenna module while being insulated from the auxiliary antenna module by the insulating film.

The antenna assembly described above may include: an antenna sheet disposed inside the cover; and an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path via which the eddy currents generated by the antenna module are guided.

The auxiliary antenna module may include: an antenna sheet disposed inside the cover; an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path via which the eddy currents generated by the antenna module are guided; and a capacitor disposed in the antenna pattern coil so as to resonate with the antenna pattern coil.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view of an antenna assembly and an electronic device according to an exemplary embodiment of the present disclosure;

FIG. 2 is a view illustrating an antenna assembly according to an exemplary embodiment of the present disclosure;

FIG. 3 is a view illustrating a coupled antenna assembly according to an exemplary embodiment of the present disclosure;

FIGS. 4A through 4C are views illustrating an auxiliary antenna module according to an exemplary embodiment of the present disclosure;

FIG. 5 illustrates an auxiliary antenna module according to another exemplary embodiment of the present disclosure;

FIGS. 6A and 6B are views illustrating magnetic-field distributions around electronic devices according to exemplary embodiments of the present disclosure;

FIGS. 7A and 7B are graphs illustrating the coverage of antennas with and without the auxiliary antenna module according to an exemplary embodiment of the present disclosure, respectively; and

FIG. 8 is a graph illustrating reflection properties of an antenna according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

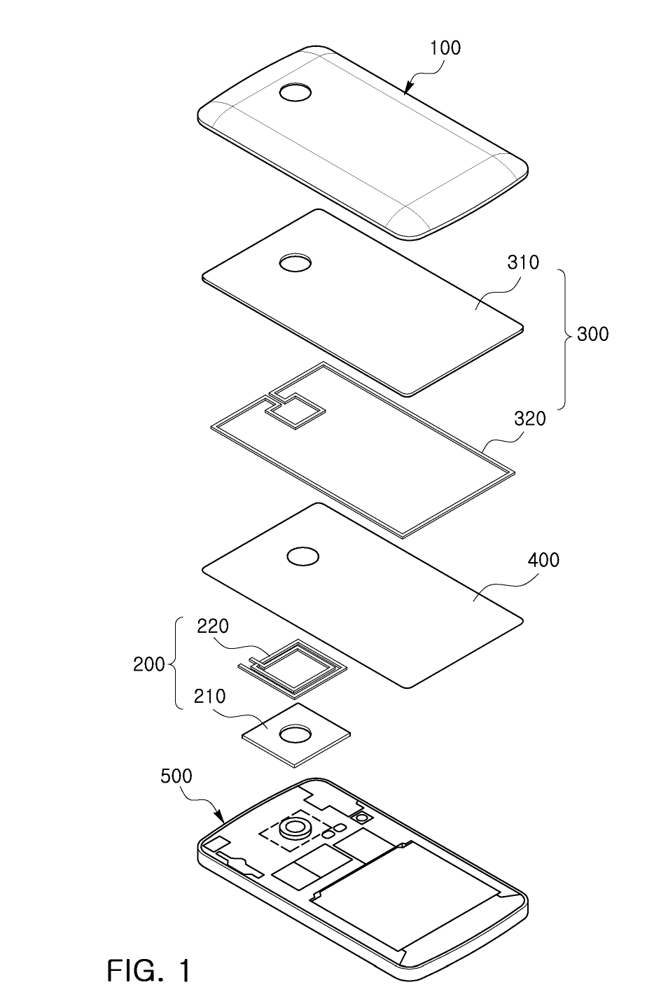

FIG. 1 is a perspective view of an antenna assembly and an electronic device according to an exemplary embodiment of the present disclosure.

Referring to FIG. 1, an antenna assembly and an electronic device according to an exemplary embodiment of the present disclosure will be described.

The antenna assembly according to the exemplary embodiment may include a cover 100, an antenna module 200, and an auxiliary antenna module 300.

The antenna assembly according to the exemplary embodiment may further include an insulating film 400 between the antenna module 200 and the auxiliary antenna module 300.

The cover 100 may be disposed inside or outside of the electronic device. For example, the cover 100 may be an outer cover or an inner cover of the electronic device. Although the cover 100 is illustrated as being the outer cover of the electronic device in the exemplary embodiment, the cover 100 is not limited to being the outer cover of the electronic device.

Further, the cover 100 may only be formed of a non-metal material such as plastic or may at least partially include metal therein. When the cover 100 includes metal material at least partially, the metal material may include aluminum (Al), magnesium (Mg), zinc (Zn), titanium (Ti), stainless steel (SUS), iron (Fe), and the like.

The antenna module 200 may be disposed inside the cover 100. For example, the antenna module 200 may be disposed inside the cover 100, on an inner cover of the body 500 of a mobile terminal, i.e., the electronic device, or on a battery. The location of the antenna module 200 is not specifically limited, as long as it is electrically connected to electrical circuits in the mobile terminal body 500.

For example, the antenna module 200 may include an antenna sheet 210, and an antenna pattern coil 220 formed on the antenna sheet 210. The antenna sheet 210 may include magnetic material such as ferrite in order to reduce eddy currents and in order to increase current concentration in the antenna pattern coil 220. The antenna pattern coil 220 may have, but is not limited to, a loop shape or a spiral shape formed along the edge of the antenna sheet 210.

The auxiliary antenna module 300 may be disposed inside the cover 100. The auxiliary antenna module 300 may be electromagnetically coupled to the antenna module 200 so as to provide a path via which eddy current generated by the antenna module 200 is guided.

The electronic device according to the exemplary embodiment may include the electronic device body 500, and the electronic device body 500 may have the antenna module 200 therein or may include an electrical circuit 510 electrically connected to the antenna module 200.

In the exemplary embodiment, a connection terminal of the electrical circuit 510 may be electrically connected to a connection terminal of the antenna module 200 in a typical manner between two circuit modules, without limitation.

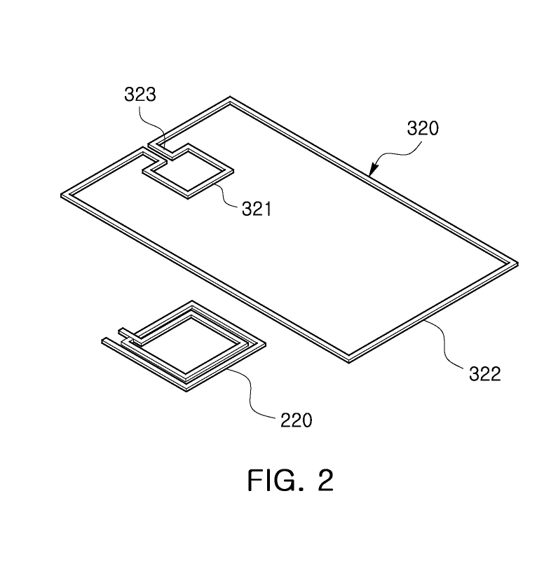

FIG. 2 is a view illustrating an antenna assembly according to an exemplary embodiment of the present disclosure.

Referring to FIG. 2, the auxiliary antenna module 300 may include an antenna sheet 310, and an auxiliary antenna pattern coil 320 formed on the antenna sheet 310.

For example, the antenna sheet 310 may be disposed inside the cover 100. The antenna sheet 310 may include magnetic material such as ferrite in order to increase the concentration of electromagnetic waves.

Further, the auxiliary antenna pattern coil 320 may include a first pattern coil 321, disposed on the antenna sheet 310 to be electromagnetically coupled to the antenna module 200, and a second pattern coil 322, connected to the first pattern coil 321 to provide a path via which eddy current caused by the antenna module 200 is guided. The first and second pattern coils 321 and 322 may be electrically connected to each other via a connection pattern 323.

In order to enhance electromagnetic coupling with the antenna module 200, the first pattern coil 321 may have the same pattern as or a similar pattern to that of the antenna pattern coil 220 of the antenna module 200 and may be disposed closely to the antenna pattern coil 220.

The second pattern coil 322 may have, but is not limited to, a loop shape or a spiral shape formed along the edge of the antenna sheet 310.

In an exemplary embodiment of the present disclosure, the auxiliary antenna module 300 may be disposed inside the cover 100. The antenna module 200 may be disposed inside the cover 100 or disposed on an inner cover of the body of a mobile terminal body 500, i.e., the electronic device, or on a battery.

When the auxiliary antenna module 300 is disposed inside the cover 100 and the antenna module 200 is disposed in the electronic body 500, an air layer may be formed between the auxiliary antenna module 300 and the antenna module 200 so that the two modules may be insulated from each other.

Alternatively, the auxiliary antenna module 300 and the antenna module 200 are disposed on the cover 100, in such a manner that the auxiliary antenna module 300 may be disposed on the cover 100 and then the antenna module 200 may be disposed on the auxiliary antenna module 300.

More specifically, when the antenna sheet 310, the auxiliary antenna pattern coil 320, the antenna pattern coil 220, and the antenna sheet 210 are sequentially disposed on one another inside the cover 100, the insulating film 400 is necessary to insulate the auxiliary antenna pattern coil 320 from the antenna pattern coil 220.

The insulating film 400 may be disposed between the auxiliary antenna module 300 and the antenna module 200. The insulating film may include an insulation substrate, an insulating film, an insulation sheet and the like, and is not limited thereto as long as it has insulating properties. Further, the insulating film may include a hole for a camera lens.

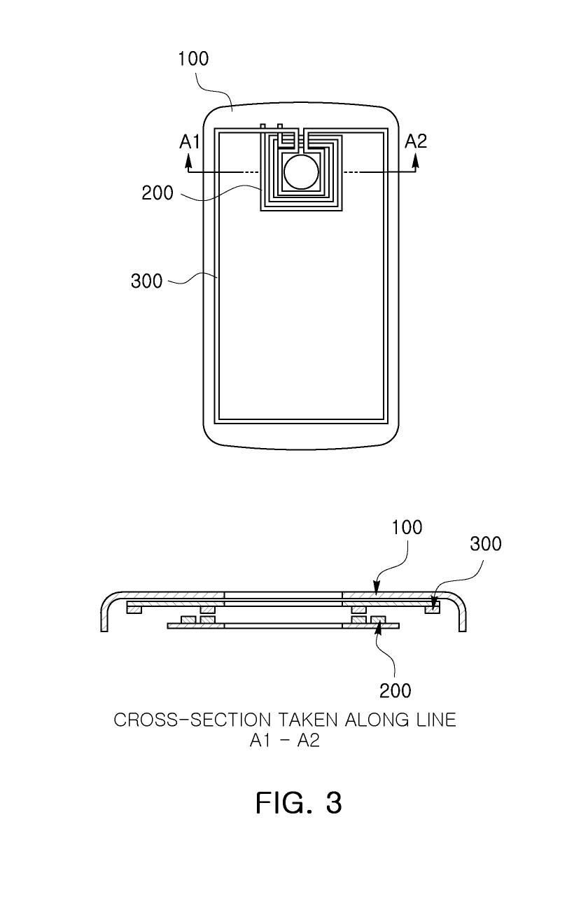

FIG. 3 is a view illustrating a coupled antenna assembly according to an exemplary embodiment of the present disclosure.

FIG. 3 illustrates a cross-section of an exemplary structure in which the auxiliary antenna module 300 is disposed inside the cover 100, and the antenna module 200 is disposed inside the auxiliary antenna module 300.

More specifically, as shown in FIG. 3, the antenna sheet 310, the auxiliary antenna pattern coil 320, the antenna pattern coil 220, and the antenna sheet 210 may be sequentially disposed inside the cover 100. Here, the insulating film 400 may be disposed between the auxiliary antenna pattern coil 320 and the antenna pattern coil 220.

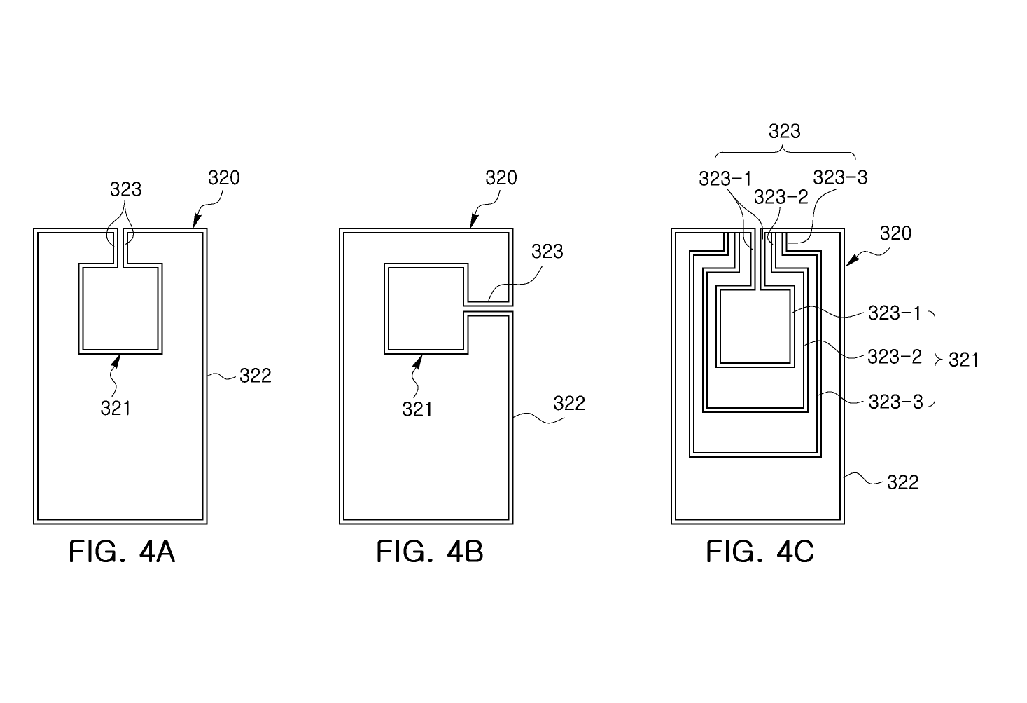

FIGS. 4A through 4C are views illustrating an auxiliary antenna module according to an exemplary embodiment of the present disclosure.

Referring to FIG. 4A, the auxiliary antenna module 300 may include a first pattern coil 321 and a second pattern coil 322, and the first pattern coil 321 and the second pattern coil 322 may be electrically connected to each other via a connection pattern 323.

Referring to FIG. 4B, the auxiliary antenna module 300 may include a first pattern coil 321 and a second pattern coil 322, and the first pattern coil 321 and the second pattern coil 322 may be electrically connected to each other via a connection pattern 323, with the connection pattern 323 located in a position different from that of FIG. 4A.

Referring to FIG. 4C, the auxiliary antenna module 300 may include first pattern coils 321 (321-1, 321-2 and 321-3) and a second pattern coil 322, and the first pattern coils 321 and the second pattern coil 322 may be electrically connected to each other via connection patterns 323 (323-1, 323-2, and 323-3).

As described above, the shape of the auxiliary antenna module 300 is not specifically limited as long as a first pattern coil 321 thereof forms electromagnetic coupling with the antenna module 200 and a second pattern coil 322 thereof provides a path via which eddy current caused by the antenna module 200 is guided so that the main current generated by the antenna module 200 is not attenuated.

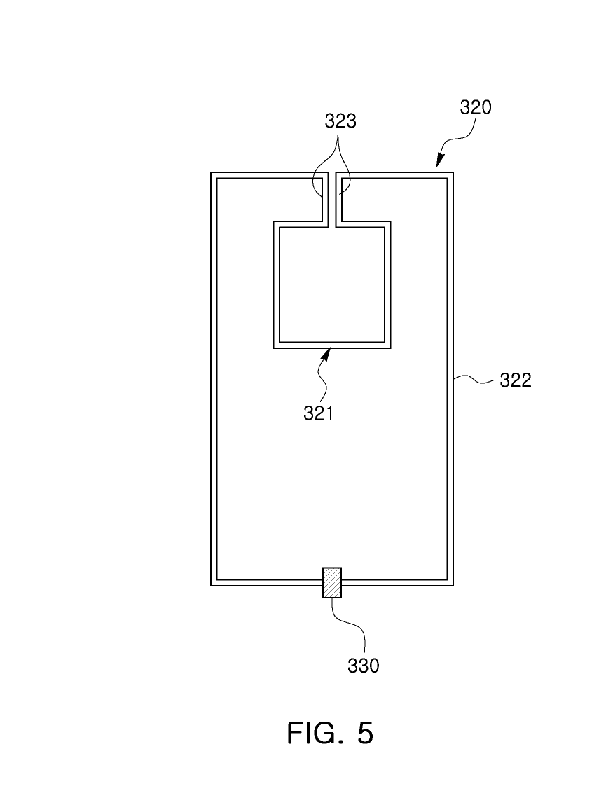

FIG. 5 illustrates an auxiliary antenna module according to another exemplary embodiment of the present disclosure.

Referring to FIG. 5, the auxiliary antenna module 300 may further include a capacitor 330.

The capacitor 330 may be disposed in the antenna pattern coil 320 so as to resonate with the antenna pattern coil 320. For example, when the inductance of the antenna pattern coil 320 and the capacitance of the capacitor 330 are in series resonance, the performance of the antenna may be improved at the resonance frequency.

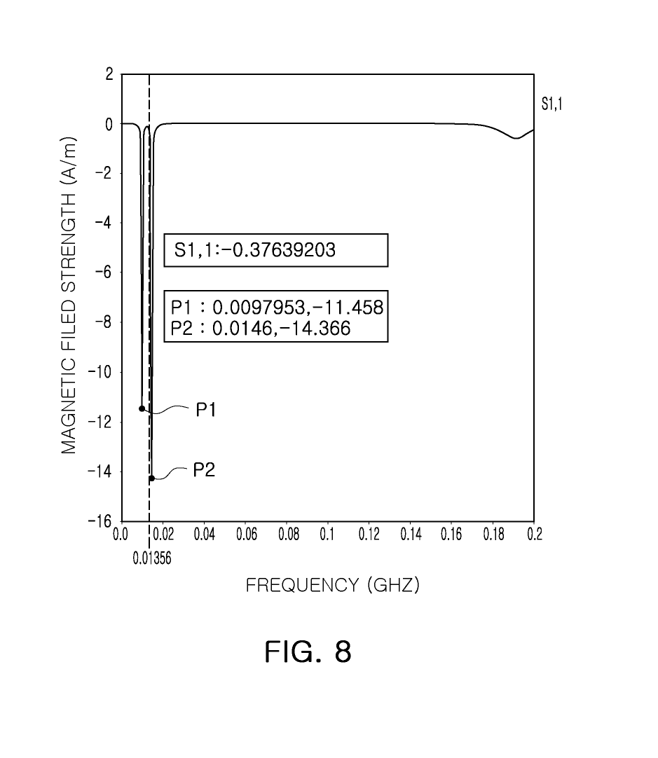

For example, when the resonance frequency is formed in the same frequency band as the electronic device according to the exemplary embodiment, transmission/reception strength may be improved. Alternatively, when the resonance frequency is made closer to the frequency band of the electronic device according to the exemplary embodiment, the frequency band of the antenna may be extended. This will be described with reference to FIG. 8.

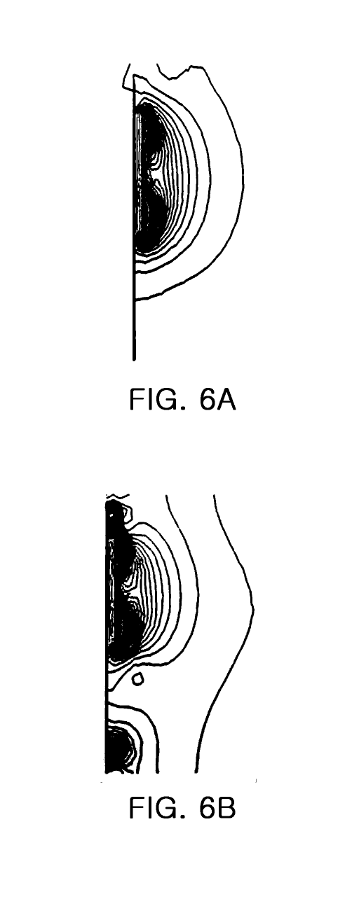

FIGS. 6A and 6B are views illustrating magnetic-field distributions around electronic devices according to exemplary embodiments of the present disclosure. FIG. 6A illustrates magnetic field (H-field) distribution generated around an electronic device with no auxiliary antenna module 300, and FIG. 6B illustrates magnetic field (H-field) distribution generated around an electronic device with an auxiliary antenna module 300.

As can be seen from FIGS. 6A and 6B, the magnetic field around the electronic device with the auxiliary antenna module 300 is relatively strong compared to the magnetic field around the electronic device without the auxiliary antenna module 300.

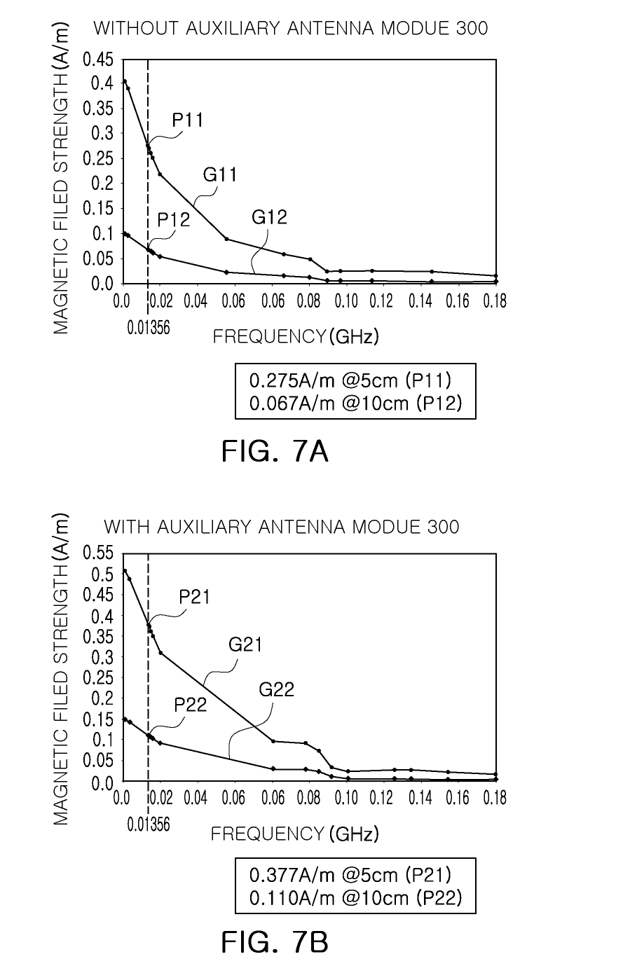

FIGS. 7A and 7B are graphs illustrating the coverage of antennas with and without the auxiliary antenna module according to an exemplary embodiment of the present disclosure, respectively. FIG. 7A is a graph illustrating the coverage of an antenna without the auxiliary antenna module 300 and FIG. 7B is a graph illustrating the coverage of an antenna with the auxiliary antenna module 300.

In FIG. 7A, graph G11 represents the magnetic field (H) at 5 cm distance at different frequencies without the auxiliary antenna module 300, and graph G12 represents the magnetic field (H) at 10 cm distance at different frequencies without the auxiliary antenna module 300.

Referring to graphs G11 and G12 shown in FIG. 7A, it can be seen that, without the auxiliary antenna module 300, the magnetic fields (H) at 5 cm distance and at 10 cm distance at the NFC frequency (13.56 MHz) are 0.275 A/m (P11) and 0.067 A/m (P12), respectively.

In FIG. 7B, graph G21 represents the magnetic field (H) at a 5 cm distance from the auxiliary antenna module 300 at different frequencies, and graph G22 represents the magnetic field (H) at a 10 cm distance from the auxiliary antenna module 300 at different frequencies.

Referring to graphs G21 and G22 shown in FIG. 7B, it can be seen that, with the auxiliary antenna module 300, the magnetic fields (H) at distances of 5 cm and 10 cm at the NFC frequency (13.56 MHz) are 0.377 A/m (P21) and 0.110 A/m (P22), respectively.

Accordingly, it can be seen from FIGS. 7A and 7B that the magnetic fields (H) are stronger with the auxiliary antenna module 300 than without the auxiliary antenna module 300. Consequently, the coverage is improved with the auxiliary antenna module 300.

FIG. 8 is a graph illustrating reflection properties of an antenna according to an exemplary embodiment of the present disclosure.

In the graph in FIG. 8 illustrating reflection properties, when the auxiliary antenna module 300 according to an exemplary embodiment of the present disclosure includes the capacitor 330 as described above, the inductance of the antenna pattern coil 320 and the capacitance of the capacitor 330 may be in resonance.

FIG. 8 illustrates the degree of reflection properties when the resonance frequency approximates to the NFC communication frequency (13.56 MHz), which is the usable frequency. In this case, the reflection properties near the usable frequency are improved, and thus the performance of the antenna may be improved.

As set forth above, according to exemplary embodiments of the present disclosure, for an electronic device with an antenna, the path of eddy currents may be changed without a physical slit being formed in a cover thereof, thereby improving the performance of the antenna.

While exemplary embodiments have been shown and described above, it will be apparent to those skilled in the art that modifications and variations could be made without departing from the spirit and scope of the present disclosure as defined by the appended claims.

What is claimed is:

1. An antenna assembly, comprising:
an antenna module disposed inside a cover disposed inside or outside of an electronic device; and
an auxiliary antenna module electromagnetically coupled to the antenna module and providing a path that guides eddy currents generated by the antenna module.

2. The antenna assembly of claim 1, further comprising: an insulating film disposed between the auxiliary antenna module and the antenna module.

3. The antenna assembly of claim 1, wherein the auxiliary antenna module includes:
an antenna sheet disposed inside the cover; and
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module.

4. The antenna assembly of claim 1, wherein the auxiliary antenna module includes:
an antenna sheet disposed inside the cover;
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guide the eddy currents generated by the antenna module; and
a capacitor disposed in the antenna pattern coil so as to resonate with the antenna pattern coil.

5. An antenna assembly, comprising:
a cover disposed inside or outside of an electronic device;
an antenna module disposed inside the cover; and
an auxiliary antenna module disposed inside the cover, the auxiliary antenna module electromagnetically coupled to the antenna module so as to provide a path that guides eddy currents generated by the antenna module, wherein the antenna module is disposed in a body of the electronic device.

6. The antenna assembly of claim 5, further comprising: an insulating film disposed between the auxiliary antenna module and the antenna module.

7. The antenna assembly of claim 5, wherein the auxiliary antenna module includes:
an antenna sheet disposed inside the cover; and
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module.

8. The antenna assembly of claim 5, wherein the auxiliary antenna module includes:
an antenna sheet disposed inside the cover;
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module; and
a capacitor disposed in the antenna pattern coil so as to resonate with the antenna pattern coil.

9. An antenna assembly, comprising:
a cover disposed inside or outside of an electronic device;
an antenna module disposed inside the cover;
an auxiliary antenna module disposed inside the cover, the auxiliary antenna module electromagnetically coupled to the antenna module so as to provide a path that guides eddy currents generated by the antenna module; and
an insulating film disposed between the auxiliary antenna module and the antenna module, wherein the antenna module is insulated from the auxiliary antenna module by the insulating film.

10. The antenna assembly of claim 9, wherein the auxiliary antenna module includes:
an antenna sheet disposed inside the cover; and
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module.

11. The antenna assembly of claim 9, wherein the auxiliary antenna module includes:
an antenna sheet disposed inside the cover; an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module; and a capacitor disposed in the antenna pattern coil so as to resonate with the antenna pattern coil.

12. An electronic device, comprising:
a cover disposed inside or outside of an electronic device;
an antenna module disposed inside the cover; and
an auxiliary antenna module disposed inside the cover, the auxiliary antenna module electromagnetically coupled to the antenna module so as to provide a path that guides eddy currents generated by the antenna module; and
a body of the electronic device in which the antenna module is disposed.

13. The electronic device of claim 12, further comprising:
an insulating film disposed between the auxiliary antenna module and the antenna module.

14. The electronic device of claim 12, wherein the auxiliary antenna module includes:
an antenna sheet disposed inside the cover; and
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module.

15. The electronic device of claim 12, wherein the auxiliary antenna module includes:
an antenna sheet disposed inside the cover;
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module; and
a capacitor disposed in the antenna pattern coil so as to resonate with the antenna pattern coil.

16. An electronic device, comprising:
a cover disposed inside or outside the electronic device;
an antenna module disposed inside the cover;
an auxiliary antenna module disposed inside the cover, the auxiliary antenna module electromagnetically coupled to the antenna module so as to provide a path that guides eddy currents generated by the antenna module;
an insulating film disposed between the auxiliary antenna module and the antenna module; and
a body of the electronic device having an electrical circuit electrically connected to the antenna module, wherein the antenna module is disposed in the auxiliary antenna module while being insulated from the auxiliary antenna module by the insulating film.

17. The electronic device of claim 16, wherein the auxiliary antenna module includes:
an antenna sheet disposed inside the cover; and
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module.

18. The electronic device of claim 16, wherein the auxiliary antenna module includes:
an antenna sheet disposed inside the cover;
an auxiliary antenna pattern coil disposed on the antenna sheet, wherein the auxiliary antenna pattern coil includes a first pattern coil electromagnetically coupled to the antenna module, and a second pattern coil connected to the first pattern coil so as to provide a path that guides the eddy currents generated by the antenna module; and
a capacitor disposed in the antenna pattern coil so as to resonate with the antenna pattern coil.
